(19) United States
(12) Patent Application Publication
(10) Pub. No.: US 2024/0109124 A1
(43) Pub. Date: Apr. 4, 2024

(54) METAL NANOSTRUCTURE PREPARATION METHOD USING GALVANIC REPLACEMENT REACTION, AND METAL NANOSTRUCTURE PREPARED THEREBY

(71) Applicant: KONKUK UNIVERSITY INDUSTRIAL COOPERATION CORP, Seoul (KR)

(72) Inventors: Jung Tae PARK, Jeonju-si (KR); Gyo Hun CHOI, Seoul (KR)

(73) Assignee: KONKUK UNIVERSITY INDUSTRIAL COOPERATION CORP, Seoul (KR)

(21) Appl. No.: 18/536,996

(22) Filed: Dec. 12, 2023

Related U.S. Application Data
(63) Continuation of application No. PCT/KR2021/018141, filed on Dec. 2, 2021.

(30) Foreign Application Priority Data
Jul. 14, 2021 (KR) 10-2021-0092339

(51) Int. Cl. B22F 1/145; B22F 1/054; B22F 1/102; C25B 11/061

(52) U.S. Cl. CPC B22F 1/145; B22F 1/0551; B22F 1/102; C25B 11/061; B22F 2301/255; B22F 2998/10; C25B 1/04

(57) ABSTRACT

Proposed are a method of preparing a metal nanostructure, which includes (a) preparing a first metal template whose surface is coated with a polymeric micelle containing an amphiphilic polymer and (b) causing the first metal template to react with a second metal ion through a galvanic replacement reaction, and a metal nanostructure prepared thereby. The amphiphilic polymer is used as a capping agent during the replacement reaction so that the micellar polymer is adsorbed onto the template, thereby selectively allowing the replacement reaction. Thus, unlike in existing technologies in which nanostructures having limited forms are prepared, nanostructures having a new two-dimensional structure, including nanostructures having a plurality of pores formed between nanoparticles, can be prepared. Additionally, a mixing ratio of two types of solvents that differ in polarity index is adjustable to control the size of the polymeric micelle, thereby changing the structural characteristics of a finally prepared metal nanostructure.

### CROSS-REFERENCE TO RELATED APPLICATIONS

This application is a continuation of International Application No. PCT/KR2021/018141 filed on Dec. 2, 2021, which claims priority to Korean Patent Application No. 10-2021-0092339 filed on Jul. 14, 2021, the entire contents of which are herein incorporated by reference.

### TECHNICAL FIELD

The present disclosure relates to a method of preparing a metal nanostructure that is usable as a catalyst for an electrode in water electrolysis and the like, using a galvanic replacement reaction, and to a metal nanostructure prepared thereby.

### BACKGROUND ART

Research on metal-based nanostructures has been conducted in various ways due to the electrical, magnetic, and catalytic properties thereof. Among various synthetic methods, research is actively in progress on methods of controlling the structure at a nanoscale level, which can be uniformly manufactured through chemical reductions.

A galvanic replacement (GR) reaction occurs when a metal comes in contact with a metal ion having a higher reduction potential.

For example, using silver (Ag) as a template to prepare a gold (Au) structure, gold nanoparticles can be prepared by melting the silver metal while being replaced with gold having a higher reduction potential.

In such a galvanic replacement reaction, polyvinylpyrrolidone (PVP), a hydrophilic polymer, has been conventionally used as a capping agent to control specific interfaces of the silver template. Each crystal plane of metal differs in degree of surface energy. In particular, PVP is dominantly attached to the {100} crystal plane of silver, which sets a limit on the interface to react with other metal ions, thereby inducing galvanic replacement reactions through the {111} plane.

However, when preparing nanostructures through galvanic replacement reactions in the presence of hydrophilic polymers, such as PVP, as in the related art, forms that enable excellent catalytic properties of nanostructures (holey nanostructure) having holes formed on the surface through selective etching are difficult to be implemented. Additionally, such forms are limited to nanostructures having several specific forms, which sets a limit on the expansion of the application fields of nanostructures.

### DISCLOSURE

### Technical Problem

The present disclosure aims to provide a method of preparing a new type of metal nanostructure that has not been conventionally reported, using a type of polymer other than a hydrophilic polymer, such as PVP, as a capping agent in preparing the metal nanostructure through a galvanic replacement reaction, and a metal nanostructure prepared thereby.

### Technical Solution

To solve the technical problem described above, the present disclosure proposes a method of preparing a metal nanostructure, which includes (a) preparing a first metal template whose surface is coated with a polymeric micelle containing an amphiphilic polymer and (b) causing the first metal template to react with a second metal ion through a galvanic replacement reaction.

In the (a), while preparing the first metal template provided for the galvanic replacement reaction through a seed-mediated growth method and the like, the first metal template is characterized in that the surface thereof is coated with the polymeric micelle containing the amphiphilic polymer.

For example, in the (a), through the seed-mediated growth method, a metal nanoplate whose surface is coated with the polymeric micelle may be synthesized from a reaction mixture containing a first metal precursor, the amphiphilic polymer, a reducing agent, and two types of solvents that differ in polarity index.

In this case, the first metal template may include any one metal selected from the group consisting of silver (Ag), copper (Cu), and cobalt (Co).

In addition, the amphiphilic polymer may be a copolymer containing a hydrophobic block selected from the group consisting of polyvinylidene chloride (PVDC), polyvinyl chloride (PVC), and polymethyl methacrylate (PMMA), and a hydrophilic block selected from the group consisting of poly(ethylene glycol) methyl ether methacrylate (POEM), 2-hydroxyethyl methacrylate (HEMA), and 2-hydroxyethyl acrylate (HEA).

In addition, one example of the two types of solvent that differ in polarity index, which are co-solvents to dissolve hydrophilic and hydrophobic portions of the amphiphilic polymer, may include a combination of tetrahydrofuran (THF) and water.

The polymeric micelle that coats or is adsorbed onto the surface of the first metal template preferably includes a hydrophilic chain and a hydrophobic core derived from the amphiphilic polymer.

The hydrophobic core forms a hydrophobic region that prevents the galvanic replacement reaction between the first metal on the first metal template and the second metal ion. Additionally, the hydrophilic chain forms a hydrophilic region that induces the galvanic replacement reaction between the first metal on the first metal template and the second metal ion. Thus, the galvanic replacement reaction in the (b) is selectively allowed depending on the surface properties of the first metal template, thereby forming a nanostructure having a new two-dimensional structure that has yet been conventionally known, such as a nanoplate (holey nanoplate) having a plurality of holes between the replaced metal nanoparticles.

On the other hand, the size of the polymeric micelle, which is determined by the size of the hydrophobic core, may be controlled by adjusting a mixing ratio of the two solvents that differ in polarity index in the reaction mixture.

For example, in the case of using tetrahydrofuran (THF) and water as the two solvents, the higher the content ratio of tetrahydrofuran (THF), which has a relatively low polarity index, among the entire solvent content, the larger the size of the polymeric micelle. Thus, the hydrophobic region that prevents the galvanic replacement reaction on the surface of the first metal template widens.

Next, in the (b), the first metal template whose surface is coated with the polymeric micelle containing the amphiphilic polymer, prepared in the (a), reacts with the second metal ion through the galvanic replacement reaction to obtain the metal nanostructure.

In the (b), the first metal template whose surface is coated with the polymeric micelle containing the hydrophobic pore and the hydrophilic chain is used to selectively allow the galvanic replacement reaction to proceed, thereby preparing a nanostructure having a new two-dimensional structure, including a nanostructure containing a plurality of holes between the metal nanoparticles.

In this case, the second metal ion may include any one metal ion selected from the group consisting of gold (Au), platinum (Pt), and palladium (Pd).

The metal nanostructure prepared by the preparation method, according to the present disclosure, may be used as a catalyst material in various fields where utilization of a large surface area is essential, such as a catalyst for an electrode in water electrolysis.

### Advantageous Effects

According to the method of preparing a metal nanostructure through a galvanic replacement reaction using an amphiphilic polymer according to the present disclosure, a micellar polymer is adsorbed onto a metal template using an amphiphilic polymer, such as polyvinylidene chloride-graft-poly(ethylene glycol) methyl ether methacrylate (PVPC-g-POEM), as a capping agent to selectively allow the galvanic replacement reaction. Thus, unlike in existing technologies in which nanostructures having limited forms, such as hollow nanoparticles, are prepared, a nanoparticle having a new two-dimensional structure, including a nanostructure having a plurality of pores formed between nanoparticles, can be prepared.

Additionally, a mixing ratio of two types of solvents that differ in polarity index is adjustable to control the size of the polymeric micelle adsorbed onto the template, thereby changing the structural characteristics of a finally prepared metal nanostructure.

The nanostructures prepared by the method of preparing the metal nanostructure, according to the present disclosure, can be used as a catalyst in various fields where utilization of a large surface area is essential.

### DESCRIPTION OF DRAWINGS

FIG. 1A shows a schematic diagram (left) illustrating a nanoplate synthesis process through a galvanic replacement reaction using an amphiphilic polymer and TEM images (right) showing changes in the microstructure of nanoplates with changes in atomic ratio of Pt/Ag (i to v are 100 to 500, respectively) among reaction conditions in examples herein, and FIG. 1B is a schematic diagram showing a mechanism of nanosurface adsorption and a galvanic replacement reaction of a polymeric micelle;

FIG. 2 is an SEM image of a nanostructure (PVP—Pt—Ag) synthesized through galvanic replacement using a hydrophilic polymer (PVP) as a capping agent;

FIG. 3 shows measurement results of changes in micelle size with varying ratios of solvents used when synthesizing a nanostructure through a galvanic replacement reaction;

FIGS. 4A, 4B, 4C show SEM images showing changes in the microstructure of nanoplates after a galvanic replacement reaction with varying ratios of solvents (THF/DI water ratio) used when synthesizing a nanostructure through the galvanic replacement reaction [(a) 7.5 vv %, (b) 19.6 vv %, (c) 28.8 vv %]; and

FIGS. 5A through 5F shows TEM images showing changes in the microstructure of nanostructures depending on silver (Ag) template forms (spherical form: (a), (c), and (e); plate-like form: (b), (d), and (f)) and types of metal to be replaced (Pt: (a) and (b); Pd: (c) and (d); Au: (e) and (f)).

### DETAILED DESCRIPTION

In describing the present disclosure, when it is determined that a detailed description of a related known function or configuration may unnecessarily obscure the gist of the present disclosure, the detailed description will be omitted.

Embodiments, according to the concept of the present disclosure, can be applied to various changes and can have various forms, so specific embodiments are illustrated in the drawings and described in detail herein or application. However, this is not intended to limit the embodiments, according to the concept of the present disclosure to a specific disclosed form, and should be understood to include all changes, equivalents, or substitutes included in the spirit and technical scope of the present disclosure.

Terms used herein are only used to describe specific embodiments and are not intended to limit the present disclosure. As used herein, the singular forms “a”, “an”, and “the” are intended to include the plural forms as well unless the context clearly indicates otherwise. Terms such as “comprise” or “have” used herein are intended to designate that the described feature, number, step, operation, component, part, or combination thereof exists, but one or more other features or numbers However, it should be understood that it does not preclude the presence or addition of steps, operations, components, parts, or combinations thereof.

Hereinafter, the present disclosure will be described in more detail through examples.

The embodiments, according to the present specification, may be modified in many different forms, and the scope of the present specification is not construed as being limited to the embodiments described below. The embodiments of the present disclosure described hereinbelow are provided for allowing those skilled in the art to more clearly comprehend the present disclosure.

### Example

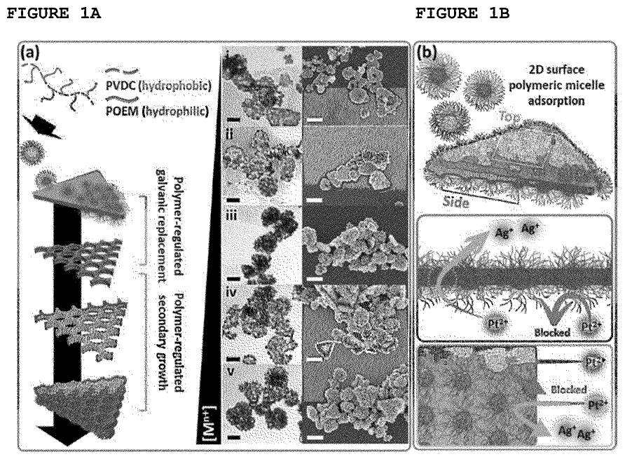

In this example, poly(vinylidene chloride)-graft-poly(oxyethylene methacrylate) (PVDC-g-POEM), an amphiphilic polymer, was first synthesized and used to prepare a silver (Ag) nanostructure, thereby preparing a PVDC-g-POEM-coated silver nanostructure in a plate-like form. Then, a platinum-silver nanostructure having a plurality of pores was prepared by undergoing a selective etching process through a galvanic replacement reaction. The amphiphilic polymer is adsorbed onto the surface of silver nanoparticles in a plate-like form to form a micelle, and only a hydrophilic portion is enabled to react with silver and metal precursor ions. In the early stages of the galvanic replacement reaction, platinum (Pt) ions used for the galvanic replacement reaction fail to infiltrate into a portion onto which a hydrophobic polymer is adsorbed. For this reason, the replacement reaction selectively proceeds only in the hydrophilic portion, and a structure thus has a holey form. After a sufficient reaction time, the silver particles inside react additionally to cover a polymeric layer (FIGS. 1A and 1B).

Specifically, as shown in (1) and (2) below, a PVDC-g-POEM-coated silver template in a plate-like form was prepared and then underwent a selective galvanic replacement reaction to prepare a platinum nanostructure having a plurality of pores.

(1) Preparation of Silver Template (PgP-AgNPs) Through Seed-Mediated Growth Method

(i) 250 mL of a 10 mM silver nitrate (AgNO₃) aqueous solution, 300 μL of a 30 mM trisodium citrate dihydrate aqueous solution, 3 mL of a PVDC-g-POEM polymer solution (9.75 mg/mL) dissolved in tetrahydrofuran (THF), 23.25 mL of distilled water, and 60 μL of a 30% hydrogen peroxide solution are mixed.

(ii) The resulting mixed solution and 250 μL of a 100 mM sodium borohydride aqueous solution are mixed with stirring.

(iii) When being reacted at room temperature for 3 hours, a blue solution of nanoseeds is obtained. This solution undergoes a second growth process without a purification process.

(iv) 125 μL of 75 mM trisodium citrate dihydrate and 375 μL of 100 mM L-ascorbic acid are added to 10 mL of the solution obtained above and diluted.

(v) 5 mL of a 1 mM silver nitrate aqueous solution, 31.3 μL of a 100 mM citric acid aqueous solution, and 2.5 μL of a 75 mM trisodium citrate dihydrate aqueous solution are added to the resulting solution at a rate of 0.2 mL/s. During this process, the resulting solution turns green, and the reaction is completed after 10 minutes.

(2) Preparation of Metal Nanoplate Through Galvanic Replacement Reaction

(i) The surface-modified nanoplate obtained through the process of (1) above is processed by adding an appropriate amount of platinum (Pt) ions at room temperature. Specifically, to synthesize PgP-Pt—Ag with a THF/DI ratio of 7.5 to 30 vv %, 80 μL of Pt²⁺ at a concentration of 10 mM is added to 4 mL of PgP-AgNPs (Pt/Ag=500) and reacted for 2 hours. PgP-Pt—Ag with THF/DI ratios of 19.6 vv % and 28.8 vv % is similarly synthesized by varying the volume ratio of the reaction solution. Galvanic replacement reactions using metals other than platinum (for example, gold and palladium) are performed by varying metal ions.

(ii) The synthesized PgP-Pt—Ag is purified by being washed at least three times using a centrifuge.

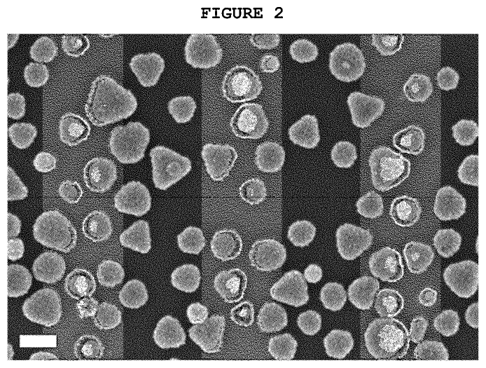

FIG. 2 is an SEM image of the nanostructure (PVP—Pt—Ag) synthesized through the galvanic replacement using the hydrophilic polymer (PVP) as a capping agent.

Referring to FIG. 2, in the case of using PVP, unlike in the case of using the amphiphilic polymer in the present disclosure, nanoparticles in a uniform form free of holes are formed.

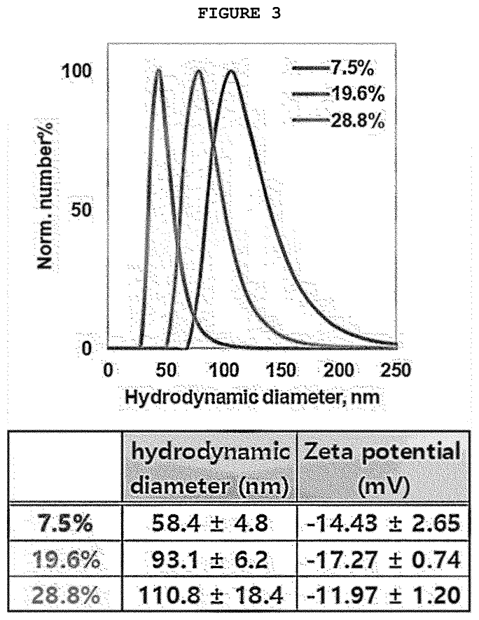

FIG. 3 shows measurement results of changes in the size of the micelle with varying ratios of THF and distilled water (DI), the solvents used when synthesizing the nanostructure through the galvanic replacement reaction.

Referring to FIG. 3, the higher the content ratio of THF, the larger the size of the micelle tended to be.

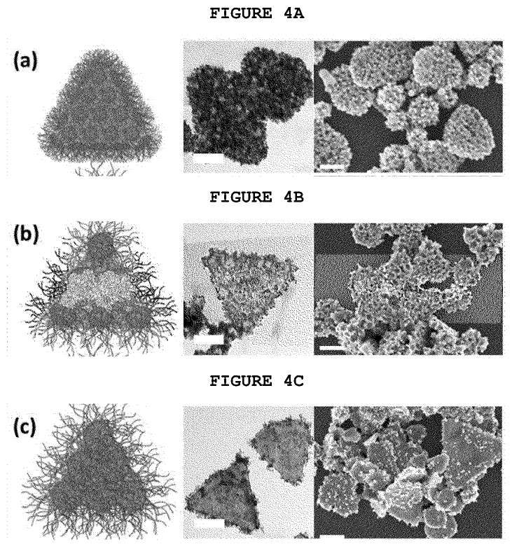

FIGS. 4A through 4C show SEM images showing changes in the microstructure of the nanoplates after the galvanic replacement reaction with varying ratios of the solvents (THF/DI water ratio) used when synthesizing the nanostructure through the galvanic replacement reaction [(a) 7.5 vv %, (b) 19.6 vv %, (c) 28.8 vv %].

Referring to FIGS. 4A through 4C, the higher the content ratio of THF, the larger the size of the micelle formed, and the size at which the galvanic replacement reaction may occur changes accordingly. When the micelle is formed to a significantly large size, the sites where sufficient galvanic replacement reactions may occur are limited, so a porous structure fails to be formed.

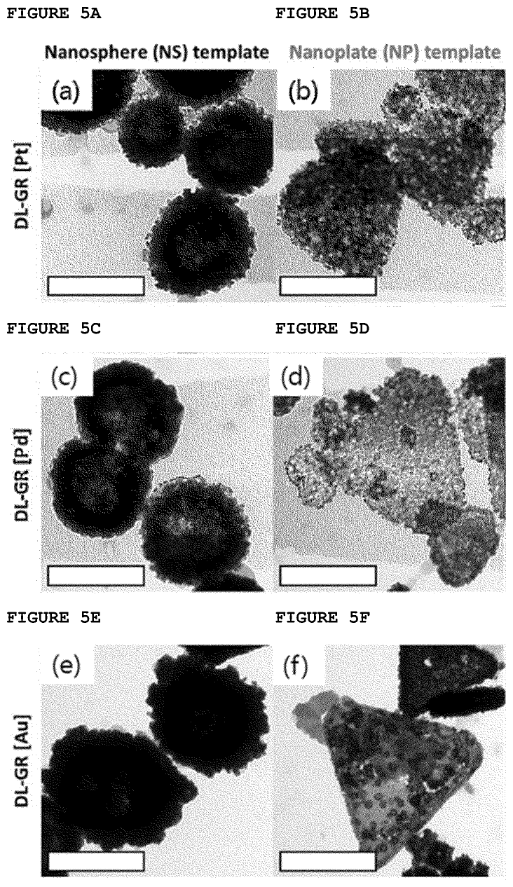

FIGS. 5A through 5F shows TEM images showing changes in the microstructure of the nanostructure depending on silver (Ag) template forms (spherical form: (a), (c), and (e); plate-like form: (b), (d), and (f)) and types of metal to be replaced (Pt: (a) and (b); Pd: (c) and (d); Au: (e) and (f)).

Referring to FIGS. 5A through 5F, when the silver particle has a spherical form, the amphiphilic polymer fails to be effectively adsorbed, and a uniform form is exhibited, rather than a structure having pores formed through a partial replacement reaction as shown in FIG. 5B. Additionally, replacement reactions were performed similarly on metals other than platinum (palladium and gold). Even though palladium exhibited a structure having pores like platinum, control of the structure was not easy in the case of gold due to the extremely fast reaction rate.

According to the present disclosure described above, PVPC-g-POEM, the amphiphilic polymer, is used as the capping agent during the galvanic replacement reaction so that the micellar polymer is adsorbed onto the metal template, thereby selectively allowing the galvanic replacement reaction. Thus, unlike in existing technologies in which nanostructures having limited forms, such as hollow nanoparticles, are prepared, a nanostructure having a new two-dimensional structure, including a nanostructure having a plurality of pores formed between nanoparticles, is capable of being prepared.

Additionally, the mixing ratio of the two types of solvents (THF and distilled water) that differ in polarity index is adjustable to control the size of the polymeric micelle adsorbed onto the template, thereby changing the structural characteristics of a finally prepared metal nanostructure.

The present disclosure is not limited to the example described above, but can be manufactured in a variety of different forms. Those skilled in the art to which the present disclosure pertains will understand that other specific forms can be implemented without changing the technical spirit or essential features of the present disclosure. Therefore, preferred embodiments of the present disclosure have been described for illustrative purposes, and should not be construed as being restrictive.

### INDUSTRIAL APPLICABILITY

A nanostructure prepared by a method of preparing a metal nanostructure through a galvanic replacement reaction using an amphiphilic polymer, according to the present disclosure, may be usable as a catalyst in various fields where utilization of a large surface area is essential.

1. A method of preparing a metal nanostructure, the method comprising:
(a) preparing a first metal template whose surface is coated with a polymeric micelle comprising an amphiphilic polymer; and
(b) causing the first metal template to react with a second metal ion through a galvanic replacement reaction.

2. The method of claim 1, wherein the polymeric micelle comprises a hydrophobic core and a hydrophilic chain,
the hydrophobic core forms a hydrophobic region that prevents the galvanic replacement reaction between the first metal on the first metal template and the second metal ion, and
the hydrophilic chain forms a hydrophilic region that induces the galvanic replacement reaction between the first metal on the first metal template and the second metal ion.

3. The method of claim 1, wherein the amphiphilic polymer is a copolymer comprising a hydrophobic block selected from the group consisting of polyvinylidene chloride (PVDC), polyvinyl chloride (PVC), and polymethyl methacrylate (PMMA) and a hydrophilic block selected from the group consisting of poly(ethylene glycol) methyl ether methacrylate (POEM), 2-hydroxyethyl methacrylate (HEMA), and 2-hydroxyethyl acrylate (HEA).

4. The method of claim 1, wherein the first metal template comprises any one metal selected from the group consisting of silver (Ag), copper (Cu), and cobalt (Co), and
the second metal ion comprises any one metal ion selected from the group consisting of gold (Au), platinum (Pt), and palladium (Pd).

5. The method of claim 1, wherein in the (a), through a seed-mediated growth method, a metal nanoplate whose surface is coated with the polymeric micelle is synthesized from a reaction mixture comprising a first metal precursor, the amphiphilic polymer, a reducing agent, and two types of solvents that differ in polarity index.

6. The method of claim 5, wherein a size of the polymeric micelle is controlled by adjusting a mixing ratio of the two types of solvents in the reaction mixture.

7. The method of claim 5, wherein the metal nanoplate whose surface is coated with the polymeric micelle is synthesized from the reaction mixture comprising silver nitrate (AgNO₃) as the first metal precursor, poly(vinylidene chloride)-graft-poly(oxyethylene methacrylate) (PVDC-g-POEM) as the amphiphilic polymer, and tetrahydrofuran (THF) and water as the two types of solvents that differ in polarity index.

8. A metal nanostructure prepared according to the method of claim 1.

9. A catalyst for an electrode in water electrolysis, the catalyst comprising the metal nanostructure of claim 8.
